(19) United States
(12) Patent Application Publication
(10) Pub. No.: US 2002/0032979 A1
(43) Pub. Date: Mar. 21, 2002

(54) Fish hook having barbs arranged in a foxtail pattern

(76) Inventor: James C. Hildman, Minden, NV (US)

Correspondence Address: James C. Hildman, P.O. Box 1412, Minden, NV, 89423, US

(21) Appl. No.: 09/956,743

(22) Filed: Sep. 18, 2001

Related U.S. Application Data
(60) Provisional application No. 60/233,336, filed on Sep. 18, 2000.

(51) Int. Cl. A01K 83/00

(52) U.S. Cl. 43/43.16

(57) ABSTRACT

A “fish hook” having multiple barbs thereon which are arranged in a foxtail pattern, respectively, and the barbs may be of different sizes and arranged in numerous configurations of choice.

### FIELD OF THE INVENTION

This invention relates to fish hook's in general but more particularly pertains to a “fish hook” having multiple barbs thereon which are substantially arranged in a foxtail pattern, and the barbs may be of different sizes and arranged in numerous configurations of choice.

### BACKGROUND OF THE INVENTION

It is to be noted, this application pertains to provisional patent application Serial No. 60/233,336 filed Sep. 18, 2000 by the same inventor.

“Fish hooks” have been known and used for many years by fisherman for catching fish. Thus, within the known prior art there have been numerous designs and apparatuses invented and each address and resolve different problems in a novel manner.

For example U.S. Pat. No. 4,953,321 entitled “FISH HOOK AND PRODUCING METHOD OF THE SAME” teaches a fish hook having barbs which are substantially angled straight outward away from the hook. Thus, the fish hook itself is functional for hooking the fish but the barbs do not provide additional holding strength therefore the barbs on this fish hook are not particularly functional, nor is such a barb design particularly desirable.

Another example is U.S. Pat. No. 5,163,245 entitled “FISH HOOK CONSTRUCTION” which teaches an interesting design wherein the fish hook is typical in construction but includes an additional barb which is engaged within the shank member by crimping.

Still a further example of similar prior art is U.S. Pat. No. 5,214,875 entitled “MULTIPLE BARB FISH HOOK”. Wherein they provide a fish hook having two barbs which are located adjacent to the penetrating point found at the end of the hook, with the barbs being spaced apart at a predetermined distance. This configuration is somewhat functional for its intended use but it is not as functional as the barb configuration of the present invention.

Other examples of known prior art include U.S. Pat. Nos. 523,988, 620,896, and 842,594, each of which teach different configurations and various patterns for barb construction. However, none suggest or recognize the advantages to be derived from a fish hook which has barbs arranged in a foxtail pattern, or the like.

### SUMMARY OF THE INVENTION

Nowhere in the prior art did the applicant's find a “fish hook” having barbs thereon which are similar in shape to the barbs such as typically found on foxtails. Foxtails in general are very well known because of their unique design and they are very difficult to remove after they have hooked into an object. Also, foxtails are known to penetrate or travel into the object in a forward direction, and if one tries to remove the foxtail in the opposing direction, removal is almost impossible without further damage to the object. For clarification purposes, I now provide a description of “foxtail” as defined within the dictionary wherein stated “foxtail is any of several grasses esp. of the genera Alopecurus, Hordeum, and Setaria with spikes resembling brushes—compare bristle grass”. Thus foxtails are a natural seed created in nature having multiple directional barbs which automatically penetrate into the object upon contact. Therefore, the present fish hook is substantially an imitation of natures own design.

It is therefore contended by the applicants that a “fish hook” having barbs which are arranged in a foxtail pattern would be most functional and would provide improved gripping strength and overcome the disadvantages of barb configurations as taught within the prior art.

It is therefore an object of the present invention to provide a novel “fish hook” having barbs which are arranged in a foxtail like pattern.

It is another object of the present invention to provide a “fish hook” which includes multiple barbs, and the barbs may be arranged into various patterns of engineering choice, such as the noted foxtail pattern, a Christmas tree pattern, or a spiral pattern, etc.

A further object of the present invention is to provide a “fish hook” having multiple barbs which may be of the same size, or the barbs may be graduated, or the “fish hook” may include a combination of different sized barbs, etc.

Still a further object of the present invention is to provide a “fish hook” which can be made from any suitable material of engineering choice, such as steel, plastic, wood, etc.

Yet another object of the present invention is to provide a “fish hook” which may be produced in various sizes of engineering choice.

Another object of the present invention is to provide a “fish hook” which is economical to manufacture and is easily marketable.

Other objects and advantages will be seen when taken into consideration with the following drawings and specification.

### BRIEF DESCRIPTION OF THE DRAWINGS

FIG. 1 is substantially an overview of the preferred embodiment for the present invention.

FIG. 2A substantially illustrates a second embodiment for the present invention.

FIG. 2B substantially illustrates a third embodiment for the present invention.

FIG. 2C substantially illustrates a fourth embodiment for the present invention.

FIG. 2D substantially illustrates a fifth embodiment for the present invention.

FIG. 2E substantially illustrates a first example of one possible pattern for arrangement of the barbs and is drawn to a different scale.

FIG. 2F substantially illustrates a second example of one possible pattern for arrangement of the barbs and is drawn to a different scale.

FIG. 2G substantially illustrates a third example of one possible pattern for arrangement of the barbs and is drawn to a different scale.

FIG. 2H substantially illustrates a fourth example of one possible pattern for arrangement of the barbs and is drawn to a different scale.

### DETAILED DESCRIPTION OF THE DRAWINGS

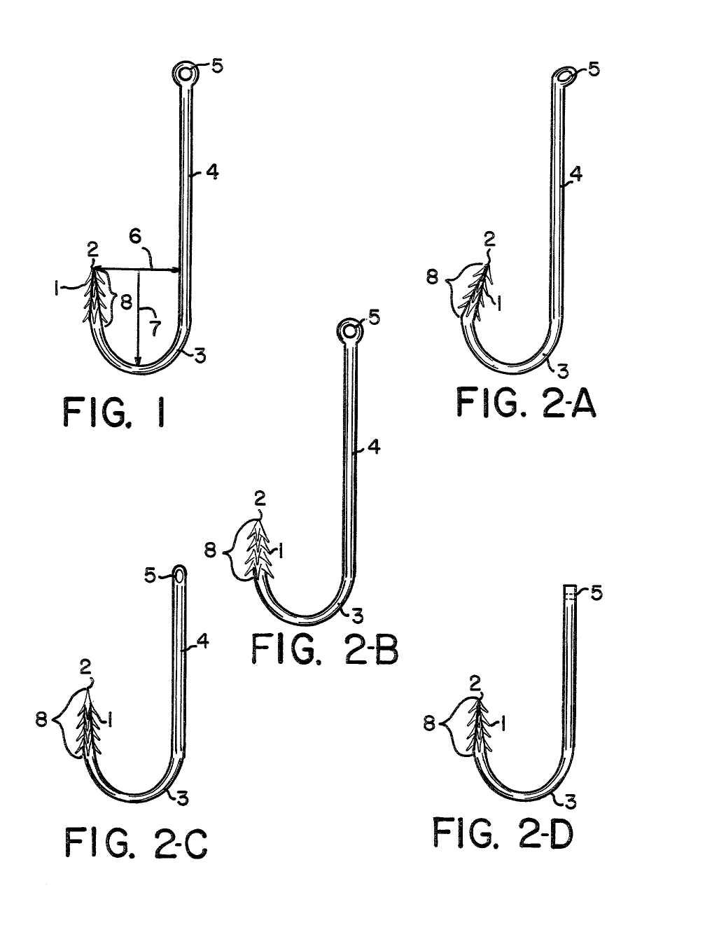

Referring now in detail to the drawings wherein like characters refer to like elements throughout the various views. In FIG. 1, we show the preferred embodiment for the present invention wherein we show a “fish hook” which is formed from an eyelet (5) which is interconnected to a shank (4). With shank (4) being substantially bent to form a curve (3) and thus forms an elongated vertical section (8) which ends in a sharp point (2) with elongated vertical section (8) having multiple barbs (1) thereon.

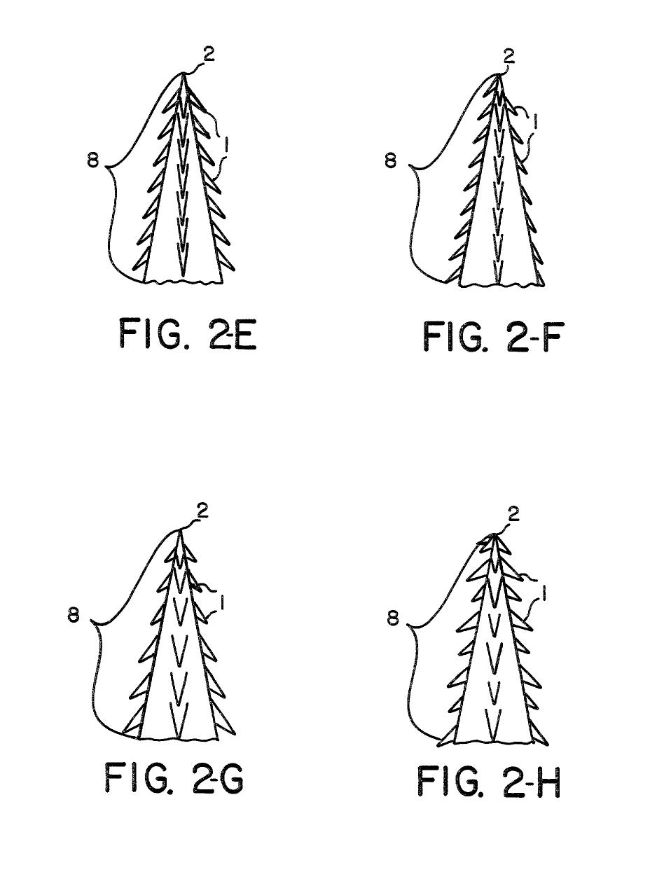

It is to be noted eyelet (5) is of a suitable shape and size to threadably receive typical fishing line (not shown) there through, and can be variably positioned, depending on engineering choice. For example, in FIGS. 1 and 2B, eyelet (5) is illustrated as being formed in the shape of a donut having an outside circumference and a circular internal opening. With the outside circumference being larger than an outside circumference of shank (4) and circular internal opening is centrally positioned in comparison with the vertical axis of shank (4), respectively.

In FIG. 2A eyelet (5) is shown having a slightly different configuration wherein eyelet (5) has an outside circumference and a circular internal opening with the outside circumference being larger than the outside circumference of shank (4). However in this embodiment, circular internal opening is slightly offset to one side in comparison with the vertical axis of shank (4), respectively.

In FIG. 2C is shown yet another way of forming eyelet (5), wherein the top end of shank (4) has a hole there through which forms the eyelet (5).

In FIG. 2D we show a slightly different embodiment wherein the eyelet (5) is substantially the same as the eyelet depicted in FIG. 2C, however the circular internal opening of FIG. 2D is cut at an angle opposite to that of the angle of circular internal opening of FIG. 2C. Thus it can be seen in FIGS. 1-2C we show the eyelet being substantially oval in shape and at an angle which is other than facing sharp point (2), while in FIG. 2D we show circular internal opening being angled in a direction which faces sharp point (2).

It is to be understood that both the distance (6) which extends between sharp point (2) and shank (4), and the distance (7) which extends between the center of curve (3) and the center of distance (6) is variable, according to engineering choice. For example, each distance (6 & 7) may be ½ inch, or the like. It is to be further noted the angle of elongated vertical section (8) is also variable depending on engineering choice. For example in FIGS. 1, and 2B-2D, elongated vertical section (8) is substantially only slightly angled, while in FIG. 2A elongated vertical section (8) is substantially at a 30 degree angle clockwise. Referring now to multiple barbs (1) which can be arranged into various patterns and also may be of any suitable size or shape of engineering choice. Thus the following description is only exemplary of some possible patterns or configurations.

Within FIG. 2E multiple barbs (1) are depicted as being all of the same size and are arranged into four vertical rows and seven horizontal rows, with each of the rows being equally spaced apart.

In FIG. 2F multiple barbs (1) are depicted as being all of the same size and are arranged into four vertical rows and seven parallel rows, with the parallel rows being at a 10 degree angle counter-clockwise, respectively, and each of the rows being equally spaced apart. Thus, each of the rows in combination form a spiral pattern, similar to the threads on a screw, or the like.

In FIG. 2G, barbs (1) are arranged in the pattern as depicted in FIG. 2E, respectively. However barbs (1) vary in size and are graduated from small to large, with the smallest being at the uppermost part of sharp point (2) and the largest being at the lowest part of elongated vertical section (8).

In FIG. 2H barbs (1) are arranged in the pattern as depicted in FIG. 2E, respectively. However barbs (1) vary in size and include a variation of different sized barbs (1). Thus, barbs (1) include small and large barbs (1) in combination and are staggered about the entire length and sides of elongated vertical section (8).

It can now be seen within the application is provided a fish hook having multiple barbs (1) which can be arranged into various configurations of choice, such as rows which form a spiral, rows that form a foxtail pattern, etc.

It can further be seen we have herein provided a fish hook which can be made from any suitable material of choice, such as metal, plastic, glass, etc.

Although the invention has been herein shown and described in what is conceived to be the most practical and preferred embodiment, it is recognized that departures may be made there from within the scope and spirit of the invention, which is not to be limited to the details disclosed herein but is to be accorded the full scope of the claims so as to embrace any and all equivalent devices and apparatus's.

What we claim as new and wish to secure by Letters Patent is:

1. A fish hook comprising: a shank having an eyelet, said shank being bent to form a curve which forms an elongated vertical section ending in a sharp point, said elongated vertical section having multiple barbs thereon, and said multiple barbs being arranged into a foxtail pattern.

2. The fish hook of claim 1 wherein said multiple barbs are arranged into four vertical rows and seven horizontal rows, and each said rows being equally spaced apart.

3. The fish hook of claim 2 wherein said multiple barbs are the same size.

4. The fish hook of claim 2 wherein said multiple barbs vary in size and are graduated from small to large, with the smallest being at the uppermost part of said sharp point and the largest being at the lowest part of said elongated vertical section.

5. The fish hook of claim 2 wherein said multiple barbs vary in size including small barbs and large barbs in combination, with said small barbs and said large barbs being staggered about the entire length and sides of said elongated vertical section.

6. The fish hook of claim 1 wherein said shank is herein further defined having an outside circumference and a vertical axis, said eyelet is formed in the shape of a donut having an outside circumference and a circular internal opening, said outside circumference of said eyelet being larger than said outside circumference of said shank, and said circular internal opening being centrally aligned with said vertical axis of said shank.

7. The fish hook of claim 1 wherein said shank is herein further defined having an outside circumference and a vertical axis, said eyelet having an outside circumference and a circular internal opening, said outside circumference of said eyelet being larger than said outside circumference of said shank, and said circular internal opening not being centrally aligned with said vertical axis of said shank.

8. The fish hook of claim 1 wherein said shank has a hole there through which forms said eyelet.

9. The fish hook of claim 8 wherein said hole is oval in shape and positioned at an angle which is other than facing said sharp point.

10. The fish hook of claim 8 wherein said hole is oval in shape and positioned at an angle which faces said sharp point.

11. The fish hook of claim 1 wherein said shank further includes a vertical axis, and said elongated vertical section is slightly angled respective to said vertical axis of said shank.

12. The fish hook of claim 11 wherein said elongated vertical section is angled at 30 degrees.

13. A fish hook comprising: a shank having an eyelet, said shank being bent to form a curve which forms an elongated vertical section ending in a sharp point, said elongated vertical section having multiple barbs thereon, and said multiple barbs being arranged into a spiral pattern.

14. The fish hook of claim 13 wherein said multiple barbs are arranged into four vertical rows and seven parallel rows, with said parallel rows being at a 10 degree angle counter-clockwise.
